(19) United States
(12) Patent Application Publication
(10) Pub. No.: US 2010/0315529 A1
(43) Pub. Date: Dec. 16, 2010

(54) IMAGING APPARATUS AND CONTROL METHOD THEREOF, AND IMAGE PROCESSING APPARATUS AND CONTROL METHOD THEREOF

(75) Inventor: Yuichi Nakase, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/814,976

(22) Filed: Jun. 14, 2010

(30) Foreign Application Priority Data
Jun. 16, 2009 (JP) 2009-143534

(51) Int. Cl. H04N 5/228

(52) U.S. Cl. 348/222.1; 348/E05.031

(57) ABSTRACT

An apparatus includes an input unit configured to input image data, a reduced image generation unit configured to reduce the input image data to a predetermined resolution to generate reduced image data, and a control unit configured to record, on a recording medium, the reduced image data as one file with the input image data if a resolution of the input image data is larger than the predetermined resolution and to record, on the recording medium, the image data as a file if the resolution of the input image data is not larger than the predetermined resolution.

### BACKGROUND OF THE INVENTION

1. Field of the Invention

The present invention relates to an imaging apparatus for handling image data and a reduced image thereof, and an image processing apparatus.

2. Description of the Related Art

Conventionally, in an image processing apparatus such as a digital camera, as an image resolution is increased, a processing time of reading and decompression of an image for playback processing has significantly been increased. To solve this situation, Japanese Patent Application Laid-Open No. 2004-072229 discusses a technique to record a display image of a medium resolution having a resolution between an original image and a thumbnail image in the same image file.

However, when a display device becomes a high resolution, it may be desirable not to use a thumbnail image but to use an image of the medium resolution as discussed in Japanese Patent Application Laid-Open No. 2004-072229 as an image for display. On the other hand, in a captured image, a low resolution may be selected in response to a use or designation by a user. In such a case, for example, the resolution of the captured image has been set low in order to reduce consumption of a recording medium. Thus, the resolution of the captured image may be made smaller than the resolution of a medium resolution image. In this case, first of all, despite a setting without needing such a large image, if an image larger than an image of the resolution for which a user is desirable is also recorded, a recording medium may uselessly be consumed.

Further, when image data and a small image reduced with the image data are recorded on a recording medium as one file, if original image data itself is subjected to reduction processing or the like by editing processing in an image processing apparatus and the original image data has been made smaller than the corresponding small image, the small image will not be needed.

Furthermore, in an image processing apparatus in which image data, a thumbnail image to be a small image corresponding to the image data, and a medium resolution image the resolution of which is smaller than the resolution of the image data and also larger than the resolution of the thumbnail image are recorded on a recording medium as one file, when executing editing which subjects image data to reduction processing, thereby causing the image data to be made smaller than the image data of the medium resolution, the image data of the medium resolution will not be needed.

### SUMMARY OF THE INVENTION

According to an aspect of the present invention, an apparatus includes an input unit configured to input image data, a reduced image generation unit configured to reduce the input image data to a predetermined resolution to generate reduced image data, and a control unit configured to record, on a recording medium, the reduced image data as one file with the input image data if a resolution of the input image data is larger than the predetermined resolution and to record, on the recording medium, the image data as a file if the resolution of the input image data is not larger than the predetermined resolution.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is an external view illustrating a digital camera as an example of an imaging apparatus according to an exemplary embodiment of the present invention.

FIG. 2 is a block diagram illustrating the configuration of a digital camera according to an exemplary embodiment of the present invention.

FIG. 3 is a flowchart illustrating the operation of the digital camera.

FIG. 4 is a flowchart illustrating a series of processing in a still image recording mode of the digital camera.

FIG. 5 is a flowchart illustrating recording processing in imaging processing and editing processing.

FIGS. 6A and 6B are diagrams illustrating a configuration example of a still image file recorded on a recording medium.

FIG. 7 is a flowchart illustrating playback processing by the digital camera.

FIG. 8 is a flowchart illustrating processing in the absence of an image in playback processing.

FIG. 9 is a flowchart illustrating processing of waiting for input of playback in playback processing.

FIG. 10 is a flowchart illustrating image editing processing in playback processing.

FIG. 11 is a flowchart illustrating file analysis processing by the digital camera.

### DESCRIPTION OF THE EMBODIMENTS

Various exemplary embodiments, features, and aspects of the invention will be described in detail below with reference to the drawings.

In the present exemplary embodiment, an imaging apparatus, such as a digital camera, capable of capturing both a still image and a moving image will be described as an example.

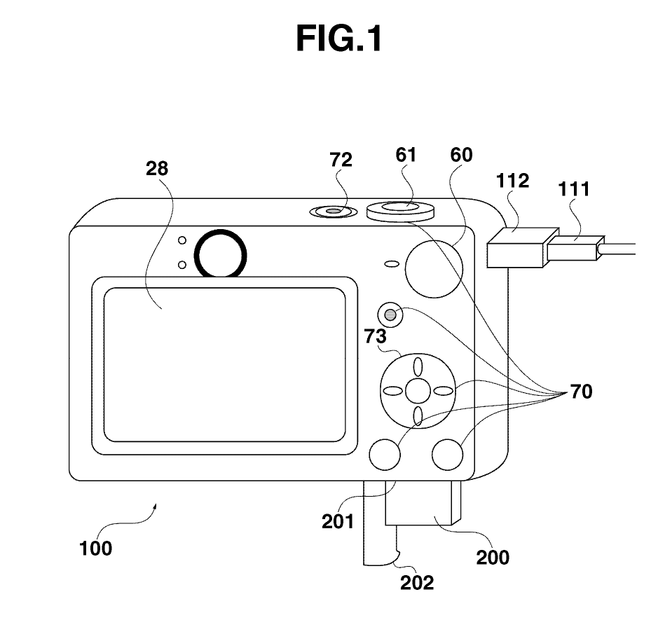

FIG. 1 is an external view illustrating a digital camera 100 according to an exemplary embodiment of the present invention. In FIG. 1, a display unit 28 displays an image and various types of information. A power switch 72 changes a power source so as to be turned ON or OFF. A shutter button 61 is provided on the top surface of the digital camera 100. A mode changing switch 60 changes various types of modes in the digital camera 100. More specifically, the mode changing switch 60 can change modes such as a still image recording mode, a moving image recording mode, and a playback mode. A connection cable 111 connects between the digital camera 100 and an external device. A connector 112 connects between the connection cable 111 and the digital camera 100.

An operation unit 70 receives various types of operations from a user. The operation unit 70 includes an operation member such as illustrated various types of buttons and a touch panel provided on a screen of an image display unit 28. The various types of buttons on the operation unit 70 will more specifically be illustrated. The various types of buttons include an erasure button, a menu button, a set button, a four-direction button disposed in the shape of a cross (top button, bottom button, right button, and left button), a wheel 73, and the like. A recording medium 200 includes a memory card, a hard disk, or the like. A recording medium slot 201 houses the recording medium 200. The recording medium 200 housed in the recording medium slot 201 can communicate with the digital camera 100. The recording medium slot 201 can be opened and closed by a lid 202.

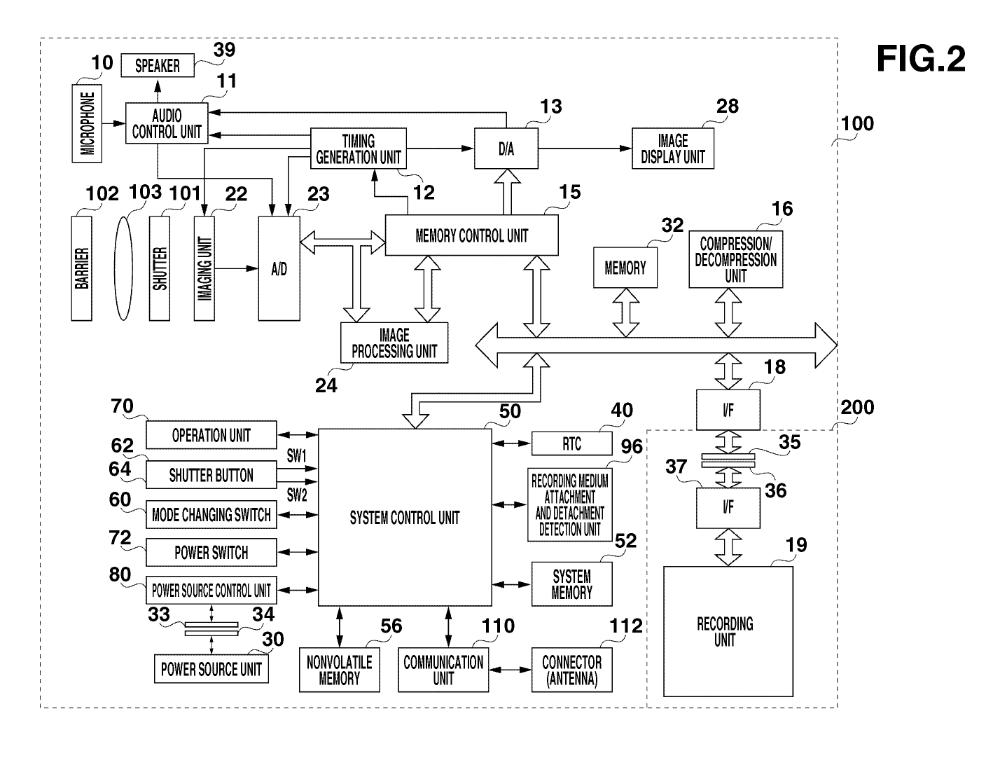

FIG. 2 is a block diagram illustrating a configuration example of the digital camera 100 according to the present exemplary embodiment. In FIG. 2, an imaging unit 22 has an image sensor (i.e., a charge coupled device (CCD), a complementary metal-oxide semiconductor (CMOS) element, etc.), which converts an optical image passing through an imaging lens 103 and a shutter 101 having a diaphragm function into an electric signal. An analog-to-digital (A/D) converter 23 converts an analog signal into a digital signal. The A/D converter 23 is used when an analog signal to be output from the imaging unit 22 is converted into a digital signal and an analog signal to be output from an audio control unit 11 is converted into a digital signal. A barrier 102 covers the lens 103 of the digital camera 100, thereby preventing an imaging system including the imaging lens 103, the shutter 101, and the imaging unit 22 from being stained and broken.

A timing generation unit 12 supplies a clock signal and a control signal to the imaging unit 22, the audio control unit 11, the A/D converter 23, and a digital-to-analog (D/A) converter 13. The timing generation unit 12 is controlled by a memory control unit 15 and a system control unit 50. An image processing unit 24 executes predetermined pixel interpolation, resizing processing such as reduction, and color conversion processing on data from the A/D converter 23 or data from the memory control unit 15. Further, the image processing unit 24 executes predetermined calculation processing using captured image data. The system control unit 50 executes exposure control and distance measurement control based on the obtained result of calculation. Thus, autofocus (AF) processing of the through the lens (TTL) method, automatic exposure (AE) processing, and flash pre-emission (EF) processing are executed. Furthermore, the image processing unit 24 executes predetermined calculation processing using captured image data and also executes auto white balance (AWB) processing of the TTL method based on the obtained result of calculation. Still furthermore, the image processing unit 24 executes reduction processing of the captured image data to generate a thumbnail image of 160×120 pixels and reduces the captured image to an image of a resolution higher than that of a thumbnail image to also generate image data of a medium resolution as an image for display.

Output data from the A/D converter 23 is written into a memory 32 via the image processing unit 24 and the memory control unit 15, or directly via the memory control unit 15. The memory 32 stores image data obtained by the imaging unit 22 and converted into digital data by the A/D converter 23, and image data for displaying on the image display unit 28. The memory 32 is also used for storing audio data recorded with a microphone 10, a still image, a moving image, and a file header for configuring an image file. Accordingly, the memory 32 has a sufficient storage capacity to store the predetermined number of still images, and a moving image and audio of a predetermined time.

A compression/decompression unit 16 compresses or decompresses image data by adaptive discrete cosine transform (ADCT). The compression/decompression unit 16, in response to the shutter 101, reads a captured image stored in the memory 32, executes compression processing, and writes the processed data into the memory 32. Further, the compression/decompression unit 16 executes decompression processing on a compressed image written into the memory 32 from a recording unit 19 of the recording medium 200, and writes the processed data into the memory 32. The image data written into the memory 32 by the compression/decompression unit 16 is made into a file by a file unit (not illustrated) in the system control unit 50 and recorded on the recording medium 200 via an interface 18. This file unit records the captured image data processed by the above-described image processing unit, a thumbnail image, and an image for display of a medium resolution (medium resolution image) on a recording medium as one file. Furthermore, the memory 32 serves as a memory for image display (video memory). The D/A converter 13 converts data for image display to be stored in the memory 32 into an analog signal to supply it to the image display unit 28. The image display unit 28 executes display corresponding to an analog signal from the A/D converter 23 on a display unit such as a liquid crystal display (LCD). Thus, the image data for display written into the memory 32 is displayed by the image display unit 28 via the D/A converter 13.

An audio signal output from the microphone 10 is supplied to the A/D converter 23 via the audio control unit 11, which includes an amplifier or the like, converted into a digital signal by the A/D converter 23, and then stored in the memory 32 by the memory control unit 15. On the other hand, audio data recorded on the recording medium 200 is read into the memory 32 and then converted into an analog signal by the D/A converter 13. The audio control unit 11 drives a speaker 39 with this analog signal to output audio.

A nonvolatile memory 56 is an electrically erasable and recordable memory. For example, an electrically erasable and programmable read only memory (EEPROM) or the like is used. In the nonvolatile memory 56, constant data, a program, and the like for operating the system control unit 50 are stored. In FIG. 2, the program refers to a program for executing various types of flowcharts, which will be described below in the present exemplary embodiment.

The system control unit 50 controls the digital camera 100. The system control unit 50 executes a program recorded into the above-described nonvolatile memory 56, thereby realizing each processing in the present exemplary embodiment, which will be described below. As a system memory 52, a random access memory (RAM) is used. On the system memory 52, constant data and variable data for operating the system control unit 50, a program read from the nonvolatile memory 56, and the like are loaded.

The mode changing switch 60, a first shutter switch 62, a second shutter switch 64, and the operation unit 70 are operation units for inputting various types of operation commands to the system control unit 50.

The mode changing switch 60 can change an operation mode on the system control unit 50 into any of a still image recording mode, a moving image recording mode, a playback mode, and the like. The first shutter switch 62 is turned ON during operation of the shutter button 61 (half press) provided on the digital camera 100 to generate a first shutter switch signal SW1. The system control unit 50 starts operations of AF processing, AE processing, AWB processing, and EF processing by the first shutter switch signal SW1.

The second shutter switch 64 is turned ON when the operation of the shutter button 61 is completed (full press) to generate a second shutter switch signal SW2. The system control unit 50 starts a series of operations of imaging processing from reading of a signal from the imaging unit 22 to writing of image data on the recording medium 200 by the second shutter switch signal SW2.

Each operation member on the operation unit 70 selectively operates various function icons displayed on the image display unit 28, thereby suitably allocating a function for each scene to serve as various types of function buttons. The function buttons include, for example, an end button, a back button, an image advance button, a search button, a search refinement button, an attribute change button, and the like. For example, when a menu button is pressed, a menu screen capable of various settings is displayed on the image display unit 28. A user can intuitively perform various settings using a menu screen displayed on the image display unit 28, and a four-direction button or a set button. The power switch 72 changes a power source so as to be turned ON or OFF.

A power source control unit 80 includes a battery detection circuit, a direct current-direct current (DC-DC) converter, a switch circuit for changing a block to be energized, and the like. The power source control unit 80 executes detection of the presence or absence of attachment of a battery, the types of batteries, and the remaining amount of a battery. Further, the power source control unit 80 controls the DC-DC converter based on the result of the detection and the command of the system control unit 50 to supply a voltage to each unit including the recording medium 200 for a period of time.

A power source unit 30 includes a primary battery such as an alkaline battery and a lithium battery, a secondary battery such as a nickel-cadmium (NiCd) battery, a nickel metal hydride (NiMH) battery and a lithium (Li) battery, and an alternating current (AC) adapter. Connectors 33 and 34 connect between the power source unit 30 and the power source control unit 80.

A real time clock (RTC) 40 counts date and time. The RTC 40 retains a power source unit inside in addition to the power source control unit 80 to continue a timing state even when the power source unit 30 is in a state of shutdown. The system control unit 50 sets a system timer using the date and time acquired from the RTC 40 in starting to execute timer control.

The interface 18 serves as an interface with the recording medium 200 such as a memory card, a hard disk, or the like. A connector 35 connects between the recording medium 200 and the interface 18. A recording medium attachment and detachment detection unit 96 detects whether the recording medium 200 is attached to the connector 35.

The recording medium 200 includes a memory card, a hard disk, or the like. The recording medium 200 includes the recording unit 19, which is configured by a semiconductor memory, a magnetic disk or the like, an interface 37 with the digital camera 100, and a connector 36 for connecting between the recording medium 200 and the digital camera 100.

A communication unit 110 executes various types of communication processing such as Recommended Standard (RS) 232C, a universal serial bus (USB), Institute of Electrical and Electronics Engineers (IEEE) 1394, P1284, a small computer system interface (SCSI), a modem, a local area network (LAN), wireless communication, and a High-Definition Multimedia Interface (HDMI). The connector (antenna in wireless communication) 112 connects the digital camera 100 with other devices via the communication unit 110.

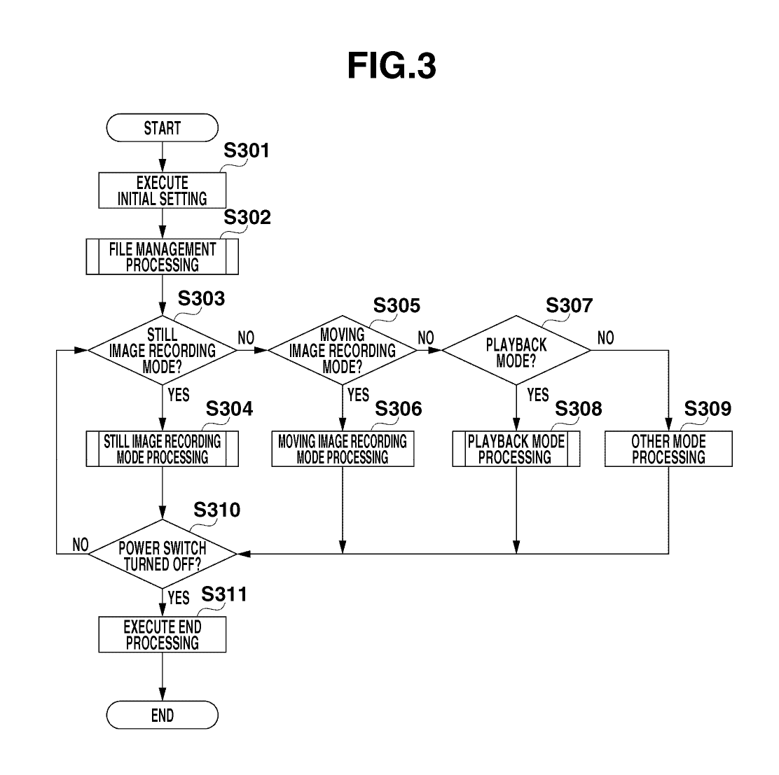

FIG. 3 is a flowchart illustrating the whole operation of the digital camera 100 in the present exemplary embodiment.

When the power switch 72 is operated and a power source is turned ON, in step S301, the system control unit 50 initializes a flag, a control variable, and the like. Then, in step S302, the system control unit 50 starts file management processing concerning a file recorded on the recording medium 200. In the file management, the system control unit 50 executes the search for an image, which is recorded on the recording medium 200 according to a predetermined standard such as Design rule for Camera File system (DCF), enumeration of an image the playback of which is allowable, and calculation of the total number thereof.

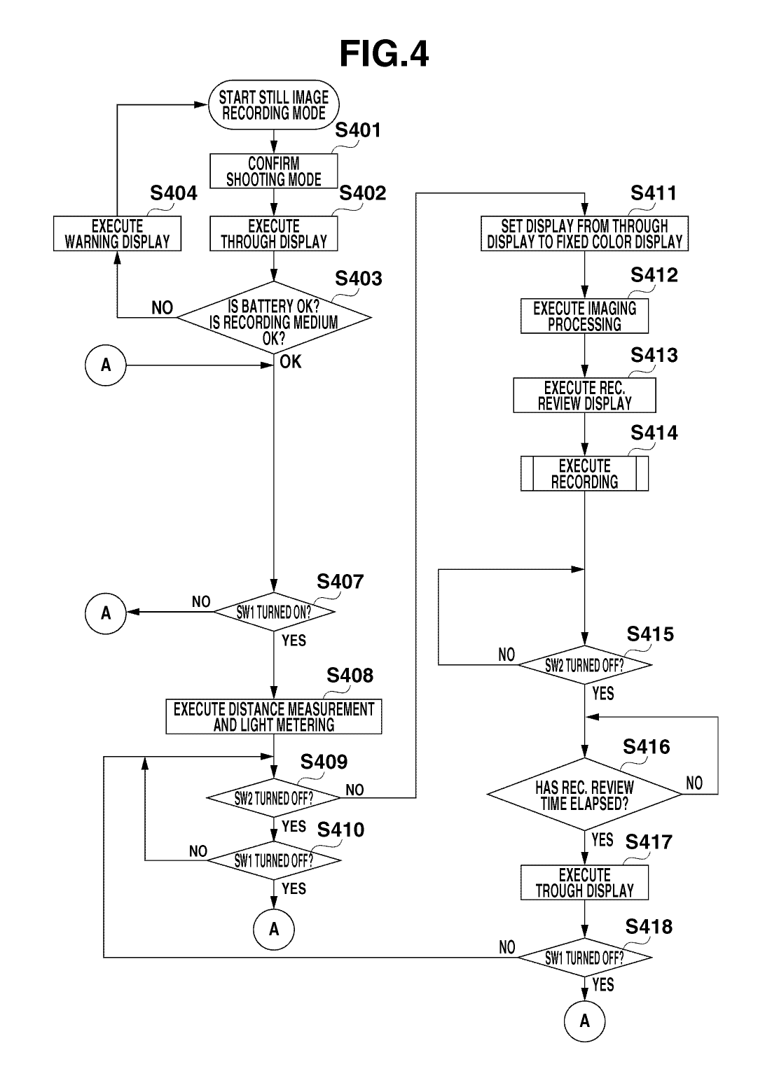

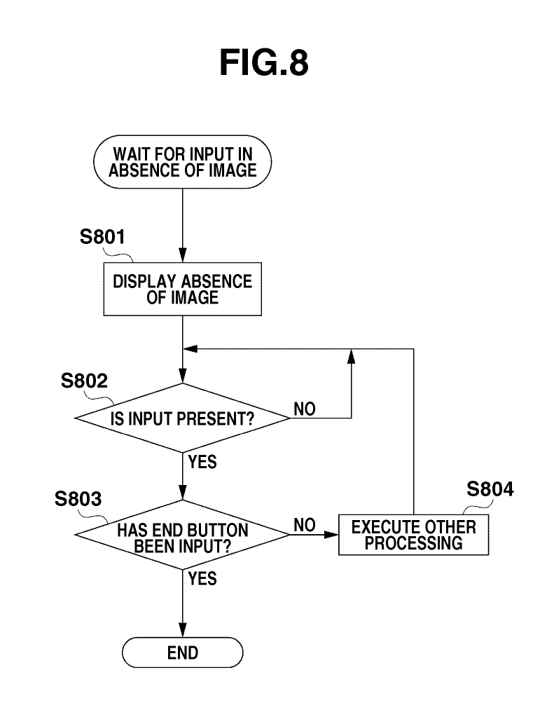

Next, in steps S303, S305, and S307, the system control unit 50 determines a setting position of the mode changing switch 60. If the mode changing switch 60 is set to a still image recording mode (YES in step S303), the processing proceeds from step S303 to step S304. The system control unit 50 executes the still image recording mode processing. The detail of the still image recording mode processing in step S304 will be described below referring to FIG. 4. If the mode changing switch 60 is set to a moving image recording mode (YES in step S305), the processing proceeds to step S306 via steps S303 and 5305. The system control unit 50 executes the moving image recording mode processing. Further, if the mode changing switch 60 is set to a playback mode (YES in step S307), the processing proceeds to step S308 via steps S303, S305 and S307. The system control unit 50 executes the playback mode processing. The playback mode processing in step S308 will be described below referring to FIG. 8.

Furthermore, if the mode changing switch 60 is set to other modes, the processing proceeds to step S309. The system control unit 50 executes processing corresponding to the selected mode. The other modes include, for example, transmission mode processing for executing transmission of a file stored in the recording medium 200 and receiving mode processing for receiving a file from an external device to store it in the recording medium 200.

After the system control unit 50 executes processing corresponding to a mode set by the mode changing switch 60 among steps S304, S306, S308 and S309, the processing proceeds to step S310. In step S310, the system control unit 50 determines a setting position of the power switch 72. If the power switch 72 is set with the power source turned ON (NO instep S310), the processing returns to step S303. On the other hand, if the power switch 72 is set with the power source turned OFF (YES in step S310), the processing proceeds from step S310 to step S311. The system control unit 50 executes end processing. The end processing includes, for example, the following processing. In the processing, display on the image display unit 28 is changed into an end state, the lens barrier 102 is closed to protect the imaging system, a flag, a parameter containing a control variable or the like, a set value, and a set mode are recorded into the nonvolatile memory 56, and a power source to a portion unnecessary for supplying power is interrupted. When the end processing in step S311 is completed, this processing ends. The processing is shifted to the state in which the power source is turned OFF.

FIG. 4 is a flowchart illustrating the still image recording mode processing in step S304 illustrated in FIG. 3. The still image recording mode processing illustrated in FIG. 4 ends by interrupt processing or the like when a change into another mode is executed by the mode changing switch 60 and when the power switch 72 is set to be turned OFF.

When the still image recording mode is started, then in step S401, the system control unit 50 confirms a shooting mode. The confirmation of the shooting mode is executed by:

(1) acquiring the shooting mode in the end of the previous still image recording mode from the nonvolatile memory 56 to store it in the system memory 52; or
(2) storing the set and input shooting mode in the system memory 52 when the operation unit 70 has been operated by a user and the setting and input of the shooting mode have been present. In FIG. 4, the shooting mode is a mode to be realized by combining a correct shutter speed and aperture value, a flash emission state, a sensitivity setting, a user interface, and the like in response to a captured image scene and a degree of skill by a user.

The digital camera 10 in the present exemplary embodiment has the following shooting mode:

a simple mode that is a mode in which a detailed setting of a user interface (UI) is omitted assuming that a user is a beginner, a basic operation guidance of a flash setting and like is displayed on a graphical user interface (GUI), and various imaging conditions of a camera are automatically determined by a program contained in the digital camera 100;

an auto mode that is a mode in which various types of parameters of a camera are automatically determined by a program contained in the digital camera 100 based on the measured exposure value;

a manual mode that is a mode in which a user can freely change various types of parameters of a camera; and

a scene mode that is a mode in which a combination of a shutter speed and an aperture value suitable for a captured image scene, a flash emission state, a sensitivity setting, and the like is automatically set.

The scene mode includes the following mode:

a portrait mode that is a mode which shades off a background to stand out a person, thereby being specialized in imaging of a person;

a night scene mode that is a mode which provides a person with flash light to record a background at a slow shutter speed, thereby being specialized in a night scene;

a landscape mode that is a mode which is specialized in an extended landscape scene;

a night and snap mode that is a mode which is suitable to beautifully capture an image of a night scene and a person without a tripod;

a kids and pet mode that is a mode which allows an image of a child or a pet frequently moving around to be captured without missing a shutter opportunity;

a fresh green leaves and red leaves mode that is a mode which is suitable to brightly capture an image of trees and leaves of fresh green leaves or the like;

a party mode that is a mode in which an image is captured by a tint close to an object with a camera shaking suppressed under a fluorescent lamp and an electric light bulb;

a snow mode that is a mode in which an image is captured without a person being darkened even if snow scenery is backed and a blue tint is left;

a beach mode that is a mode which allows an image to be captured without a person or the like being darkened even on the surface of the sea or a sandy beach strong in reflection of sunlight;

a fireworks mode that is a mode in which an image of a skyrocket is vividly captured with most suitable exposure;

an aquarium mode that is a mode in which sensitivity, a white balance, and a tint suitable to capture an image of a fish or the like in an indoor aquarium are set; and

an underwater mode that is a mode in which a white balance most suitable for the underwater is set to capture an image with a tint the blue of which is reduced.

In step S402, after the shooting mode is confirmed in step S401, then, the system control unit 50 executes through display which displays image data from the imaging unit 22. Subsequently, in step S403, the system control unit 50 determines the remaining capacity of the power source unit 30 configured by a battery or the like, the presence or absence of the recording medium 200, and the remaining capacity thereof as to whether there may be an issue in operation of the digital camera 100 using the power source control unit 80. If there is an issue (NO in step S403), then in step S404, the system control unit 50 executes predetermined warning display by an image or audio using the image display unit 28. Then, the processing returns to step S401.

If, concerning a state of the power source unit 30 or the recording medium 200, there is not an issue (OK in step S403), then in step S407, the system control unit 50 determines an ON/OFF state of the first shutter switch signal SW1. If the first shutter switch signal SW1 is turned ON (YES in step S407), then in step S408, the system control unit 50 executes distance measurement and light metering. Then, in steps 409 and 410, the system control unit 50 determines an ON/OFF state of the first shutter switch signal SW1 and the second shutter switch signal SW2. When the second shutter switch signal SW2 is turned ON (NO in step S409) with the first shutter switch signal SW1 turned ON, the processing proceeds from step S409 to step S411. When the first shutter switch signal SW1 is turned OFF (YES in step S410) (when second shutter switch signal SW2 is not turned ON (YES in step S409) and further the first shutter switch signal SW1 is also turned OFF (YES in step S410)), the processing returns from step S410 to step S407. Further, during the time when the first shutter switch signal SW1 is turned ON (NO in step S410) and the second shutter switch signal SW2 is turned OFF (YES in step S409), processing in steps S409 and S410 is repeated.

When the second shutter switch signal SW2 is pressed, then in step S411, the system control unit 50 sets the display state of the image display unit 28 to a fixed color display state from through display. Then, in step S412, the system control unit 50 executes imaging processing including exposure processing and development processing. In the exposure processing, image data obtained via the imaging unit 22 and the A/D converter 23 is written into the memory 32 via the image processing unit 24 and the memory control unit 15, or directly via the memory control unit 15 from the A/D converter 23. Further, in the development processing, using the memory control unit 15 and, as needed, the image processing unit 24, the system control unit 50 reads the image data written into the memory 32, executes various types of processing, and obtains captured image data. Also in a thumbnail image reduced with this captured image data, the processing in step S413 is executed.

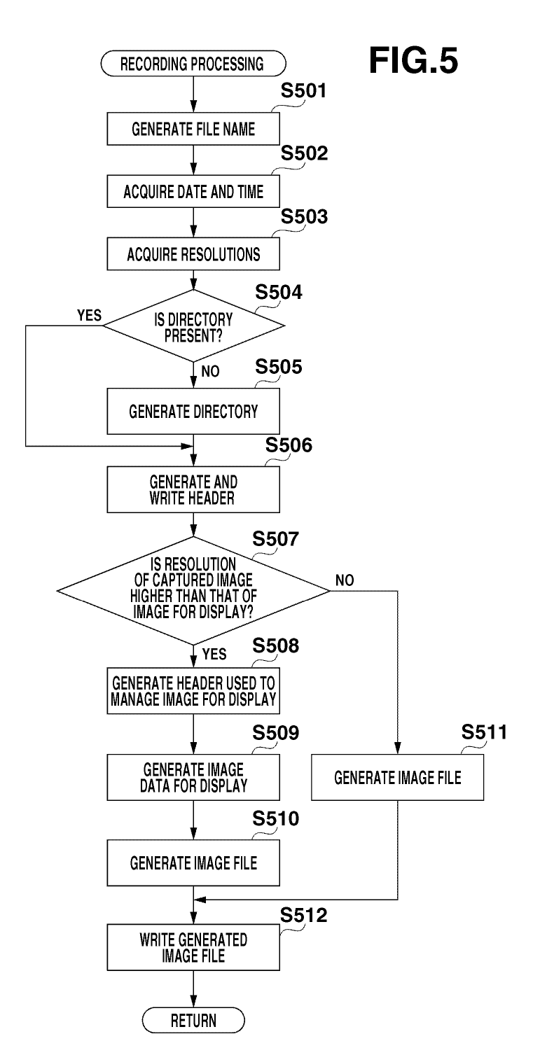

Next, in step S413, the system control unit 50 executes rec. review display of the image data obtained by the imaging processing on the image display unit 28. The rec. review is processing for displaying image data on the image display unit 28 for a predetermined time (review time) before recording on a recording medium after imaging of an object in order to confirm the captured image. After the rec. review display, then in step S414, the system control unit 50 executes recording processing for writing the image data obtained by the imaging processing into the recording medium 200 as an image file. The detail of this recording processing will be described below referring to FIG. 5.

After the recording processing in step S414 ends, then in step S415, the system control unit 50 determines an ON/OFF state of the second shutter switch signal SW2. When the second shutter switch signal SW2 is turned ON (NO in step S415), the processing repeats determination in step S415 and waits for the second shutter switch signal SW2 to be turned OFF. During this period, the above-described rec. review display is continued. In other words, when the recording processing in step S414 has ended, the rec. review display on the image display unit 28 is continued until the second shutter switch signal SW2 is turned OFF. With this configuration, a user continues the state of full press of the shutter button 61, thereby allowing confirmation of the captured image using the rec. review to be carefully executed.

After the user has performed imaging with the shutter button 61 being in the state of full press, when the state of full press is released by leaving hands from the shutter button 61 or the like, the processing proceeds from step S415 to step S416. In step S416, the system control unit 50 determines whether a predetermined review time has elapsed. If the review time has elapsed (YES in step S416), the processing proceeds to step S417. In step S417, the system control unit 50 returns the display state on the image display unit 28 from the state of the rec. review display to the state of the through display. By this processing, after the captured image data has been confirmed by the rec. review display, the display state on the image display unit 28 is automatically changed into the through display state, in which image data from the imaging unit 22 is successively displayed for next imaging.

Then, in step S418, the system control unit 50 determines ON/OFF of the first shutter switch signal SW1. When the first shutter switch signal SW1 is turned ON (NO in step S418), the processing proceeds to step S409. When the first shutter switch signal SW1 is turned OFF (YES in step S418), the processing returns to step S407. In other words, when the state of half press of the shutter button 61 is continued (the first shutter switch signal SW1 is turned ON (NO in step S418)), then in step S409, the system control unit 50 prepares for next imaging. On the other hand, when the shutter button 61 has been in a released state (the first shutter switch signal SW1 is turned OFF (YES in step S418)), the system control unit 50 ends a series of imaging operations. The processing returns to an imaging standby state in step S407.

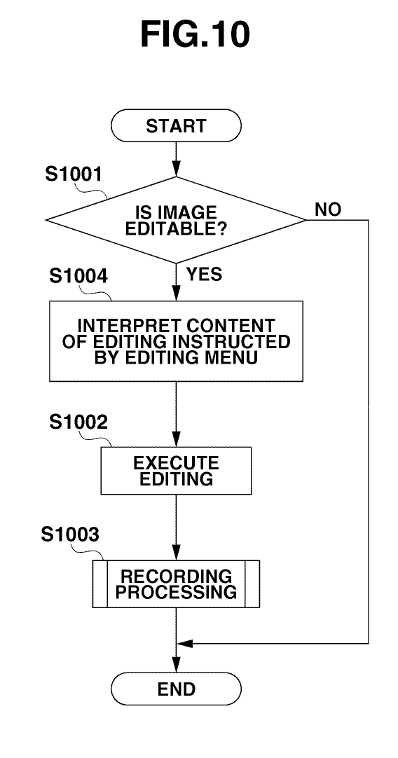

FIG. 5 illustrates recording processing of image data generated in an imaging sequence in step S414 illustrated in FIG. 4 and in an editing sequence in step S1003 illustrated in FIG. 10.

After recording processing is started, then in step S501, the system control unit 50 generates a file name to image data to be recorded according to a predetermined file name generation rule such as the DCF. Next, in step S502, the system control unit 50 acquires information on the date and time stored in the system memory 52. Then, in step S503, the system control unit 50 acquires the resolutions of the captured image data to be stored in an image file, which is generated from the image data for recording, and the image data for display. The resolution of the captured image data has been set by a user in advance and adapted in imaging processing and editing processing. For example, in a digital camera using a CCD of 12 mega pixels, a setting can be selected from some options as 4,000×3,000 pixels, 2,400×1,800 pixels, 1,600×1,200 pixels, and 640×480 pixels. This resolution may also automatically be determined by captured image conditions, object conditions, and other information. Similarly, the resolution of the image data for display may also be set by a setting of a user in advance or fixed by an aspect ratio of the captured image data. Further, the display resolution of the connected display device is acquired and the most suitable resolution may also be determined. The image data for display is medium resolution image data having a resolution suitable for display and is an image larger than the thumbnail image.

In the present exemplary embodiment, a user can select an image for display of two types of 2,000×1,500 pixels and 1,200×900 pixels using the operation unit 70. Then, the user not only selects either thereof but also may perform setting to record the images for display of both resolutions in one file. The resolution of the captured image data, the resolution of the image for display, and the number of options are not limited to the setting illustrated above. Further, these can be changed by the capability and the design of a digital camera.

When the captured image data has high resolution, it is expected that in reading from a recording medium of the captured image data and decompression processing, time is consumed. Thus, in a display device, the image data for display making a resolution lower than that of the captured image is decompressed, thereby allowing it to be displayed at a high speed. When a user performs a setting of the resolution of a captured image and a setting of the resolution of an image for display, the user can perform the setting using the operation unit 70 while viewing a menu displayed on the image display unit 28.

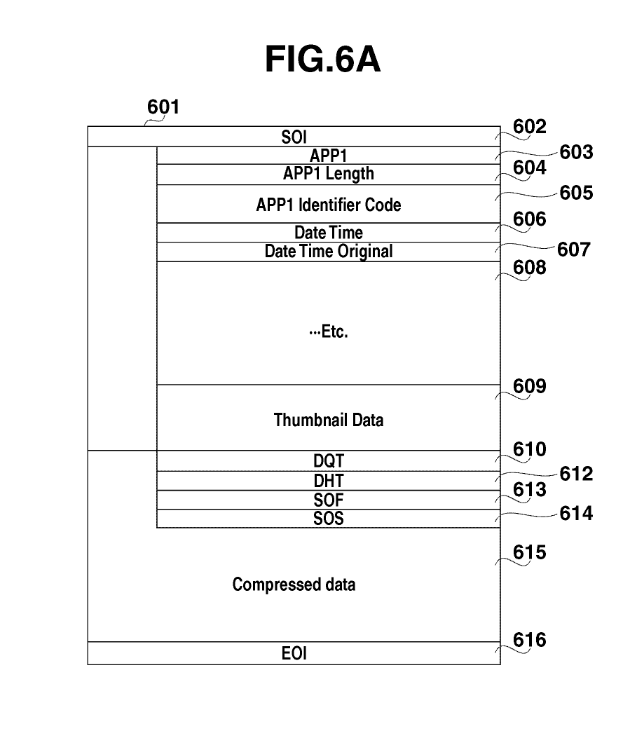

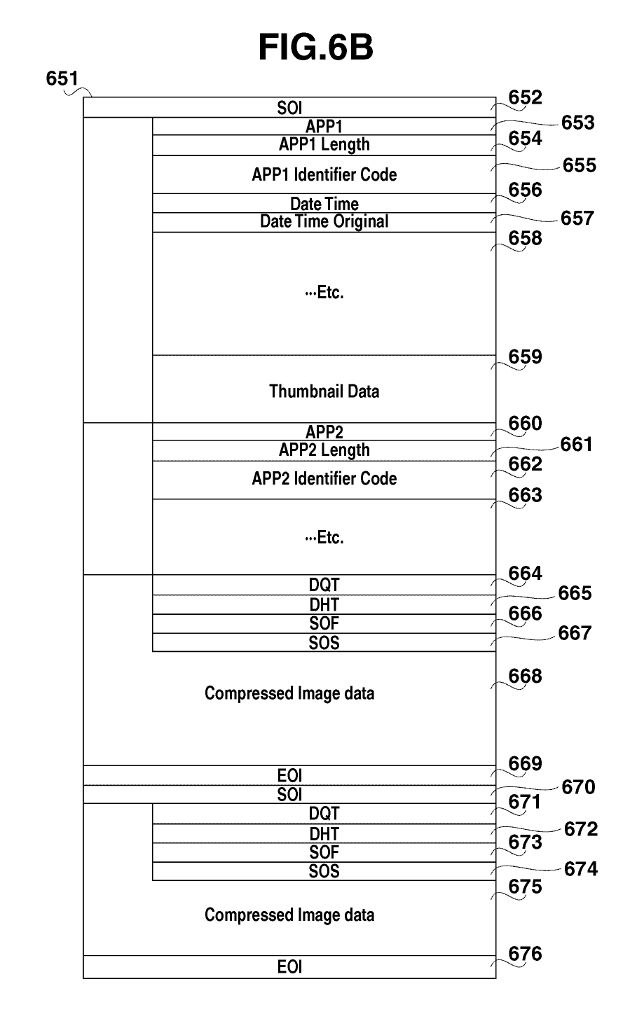

In step S504, the system control unit 50 determines whether a directory that is used to store an image file generated from the image data is present in the recording medium 200. When the directory is not present (NO instep S504), the processing proceeds to step S505. In step S505, the system control unit 50 generates a directory for storing an image file. Subsequently, in step S506, the system control unit 50 generates a file header including the date and time of the captured image, conditions in imaging, and the like to the image data stored in the memory 32 in the above-described imaging processing. A header and a file configuration to be generated will be described below in FIGS. 6A and 6B. Next, in step S507, the system control unit 50 executes a comparison of resolutions between the captured image data and the image data for display acquired in step S503. When it has been determined that the resolution of the captured image data is higher than that of the image data for display (YES in step S507), the processing proceeds to step S508. In step S508, the system control unit 50 generates a file header for managing the image data for display to be generated from the image data stored in the memory 32 in the above-described imaging processing. Next, in step S509, the system control unit 50 reduces the captured image data to generate image data for display. In step S510, the system control unit 50 generates an image file including the captured image data, the thumbnail image, and the medium resolution image data for display as one file.

On the other hand, when it has been determined that the resolution of the captured image data is not higher than that of the image data for display (NO in step S507), the processing proceeds to step S511. In step S511, the system control unit 50 generates an image file including the captured image data and the thumbnail image obtained by reducing the captured image data as one file. In step S512, the system control unit 50 writes the image file generated up to here into a recording medium, and then exits the processing.

As described above, when the resolution of the captured image data is lower than the resolution of the image data for display which is a medium resolution, the system control unit 50 does not write the image data for display. In other words, the purpose of the image data for display is first of all to avoid a processing load of image data large in a data size. Thus, if the resolution of the captured image data is equal to or lower than the resolution of the image data for display, the image data for display is not required to be recorded, thereby also saving the capacity of a recording medium. In the present exemplary embodiment, an example has been provided by comparing the resolutions in magnitude. However, a predetermined ratio of the resolutions between the captured image data and the image data for display may be conditioned.

Even when two types or more of images for display different in resolution are recorded, an image for display the resolution of which is smaller than the resolution of the captured image data may not be recorded in a file in response to a setting of the resolution of the captured image data.

In other words, the system control unit 50 performs control to record only one medium resolution image for display or not to record any medium resolution image.

Subsequently, an example of a structure of data on a still image file to be recorded on the recording medium 200 in the above-described recording processing is illustrated in FIGS. 6A and 6B.

FIG. 6A illustrates a file structure when image data for display has not been written in the above-described recording processing.

An image file 601 has a marker (SOI) 602, which indicates start of an image file at the front, and an application marker (APP1) 603, which corresponds to a header part, following the marker 602. The application marker (APP1) 603 includes:

a size (APP1 Length) 604,

an identification code of the application marker (APP1 Identifier Code) 605,

the date and time to generate image data (Date Time) 606,

the date and time generated with image data (Date Time Original) 607,

other shooting information 608, and

the above-described thumbnail image (Thumbnail Data) 609. In FIG. 6A, in an image captured by a digital camera or the like, as an identification code of the application marker, generally, a character string of “Exif” is recorded. By interpreting this identification code, the image can be determined to be an Exif image.

Further, captured image data to be recorded in the image file 601 includes a quantization table (DQT) 610, a Huffman table (DHT) 612, a frame start marker (SOF) 613, a scan start marker (SOS) 614, and compressed data 615. Then, the captured image data is terminated by a marker (EOI) 616, which indicates the end of image file data.

FIG. 6B illustrates a file structure when image data for display is written in the above-described recording processing.

An image file 651 has a marker (SOI) 652, which indicates start of an image file at the front, and an application marker (APPI) 653, which corresponds to a header part, following the marker 652. The application marker (APP1) 653 includes:

a size (APP1 Length) 654,

an identification code of the application marker (APP1 Identifier Code) 655,

the date and time to generate image data (Date Time) 656,

the date and time generated with image data (Date Time Original) 657,

other shooting information 658, and

the above-described thumbnail image (Thumbnail Data) 659. In FIG. 6B, in an image file captured by a digital camera or the like, as an identification code of the application marker APP1, generally, a character string of “Exif” is recorded. By interpreting this identification code, the image can be determined to be an Exif image.

Further, captured image data to be recorded in the image file 651 includes a quantization table (DQT) 664, a Huffman table (DHT) 665, a frame start marker (SOF) 666, a scan start marker (SOS) 667, and compressed data 668. Then, the captured image data is terminated by a marker (EOI) 669, which indicates the end of image file data.

Furthermore, the captured image data includes an application marker (APP2) 660 following the application marker (APP1) 653. The application marker (APP2) 660 includes:

a size (APP2 Length) 661,

an identification code of the application marker (APP2 Identifier Code) 662, and

other shooting information 663.

In FIG. 6B, in an image file captured by a digital camera or the like which records image data for display, as an identification code of the application marker APP2, generally, a character string of “MPF” is recorded. By interpreting this identification code, the image can be determined to be an image file having a medium resolution image for display other than the captured image. Further, the other shooting information 658 also includes data that indicates a position in an image file of the image data for display.

Still furthermore, the image data for display to be recorded in the image file 651 includes a marker (SOI) 670, which indicates start of the image data for display, a quantization table (DQT) 671, a Huffman table (DHT) 672, a frame start marker (SOF) 673, a scan start marker (SOS) 674, and compressed data 675. Then, the image data for display is terminated by a marker (EOI) 676, which indicates the end of image file data.

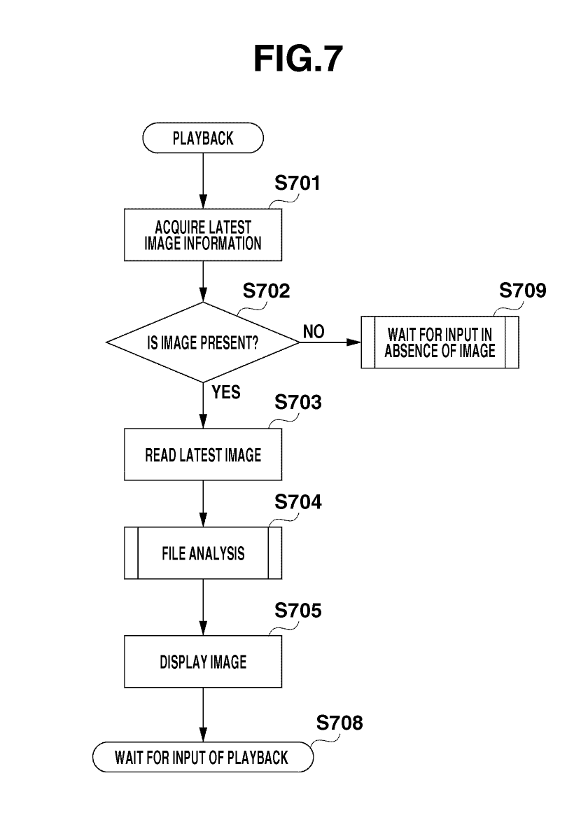

FIG. 7 is a flowchart illustrating the operation of a playback mode of the digital camera 100 in the present exemplary embodiment. The flowchart in FIG. 7 illustrates a detail in step S308 illustrated in FIG. 3.

In step S701, the system control unit 50 acquires latest image information from the recording medium 200. This has the benefit of executing acquisition of the latest image information prior to calculation of the total number of images, thereby allowing image display of the processing to be swiftly executed when entering the playback mode. In step S702, the system control unit 50 checks whether acquisition of the latest image information in step S701 has correctly been executed. When the latest image information has not been able to be acquired (NO instep S702), the processing proceeds to step S709. In step S709, the system control unit 50 enters the state of waiting for input in the absence of an image. Processing in step S709 will be described below using a flowchart in FIG. 8. As a case in which the latest image information cannot be acquired, a state in which there is no image, a state in which image information cannot be acquired by a failure of media, and the like are considered. When the latest image information can be acquired (YES in step S702), it is determined that at least one image is present. Then, the processing proceeds to step S703.

In step S703, the system control unit 50 reads latest image data from the recording medium 200 based on the latest image information acquired in step S701. Then, in step S704, the system control unit 50 executes file analysis processing to acquire shooting information, attribute information, and the like of an image in the read latest image data. The file analysis processing will be described below. In step S705, the system control unit 50 displays the read latest image data. Further, at this time, the system control unit 50 also displays the shooting information, the attribute information, and the like acquired in step S704. Furthermore, in response to the result of the file analysis in step S704, if it is determined that apart of the file is broken, error display is also executed therewith.

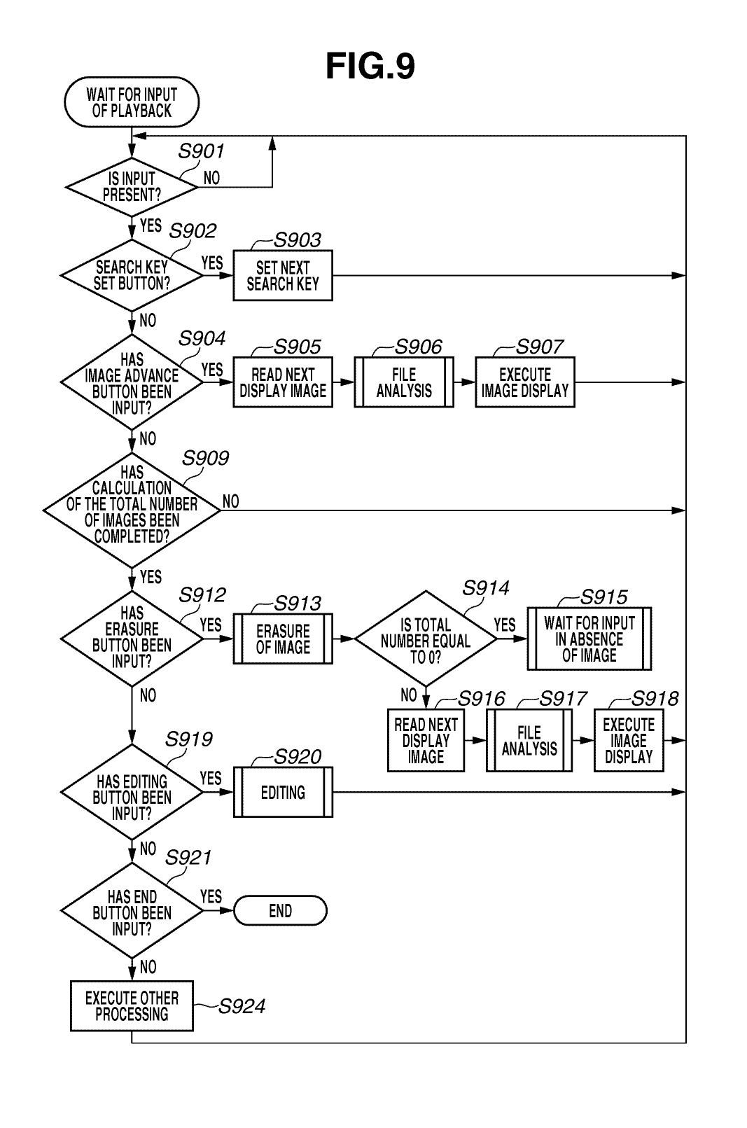

In step S708, the system control unit 50 enters the state of waiting for input. Processing in this state of waiting for input will be described below using a flowchart in FIG. 9.

FIG. 8 is a flowchart illustrating processing in the state of waiting for input in the absence of an image in a playback mode.

First, in step S801, the system control unit 50 executes message display of “image is absent” on the image display unit 28 in order to notify a user of the absence of image data. Next, in step S802, the system control unit 50 waits for an operated input. In FIG. 8, the operated input includes a button by a user, an operation to the lid of a battery, an event that notifies of a reduction in a power source, and the like. When some input has been present (YES in step S802), the processing proceeds to step S803. In step S803, the system control unit 50 checks whether the input is an end button. When it has been determined that the input is the end button (YES in step S803), the playback mode processing ends. Then, the processing proceeds to step S310 in FIG. 3. On the other hand, when the operated input is other than the end button (NO in step S803), the processing proceeds to step S804. In step S804, processing corresponding to the operated input is executed. For example, when the operation of a menu button has been input even if image data is absent, the system control unit 50 executes menu display on the image display unit 28 to allow a user to execute change of a setting or the like.

FIG. 9 is a flowchart illustrating processing of the state of waiting for input in playback mode processing.

In step S901, the system control unit 50 checks whether an operated input by a user is present. In FIG. 9, the operated input includes a button by a user, an operation to the lid of a battery, an event that notifies of a reduction in a power source, and the like. When there is not any input (NO instep S901), the processing waits until an input is present. When there has been some operated input (YES in step S901), the processing proceeds to step S902.

In step S902, the system control unit 50 determines whether the operated input is a search key set button, which is contained in the operation unit 70. If the operated input is the search key set button (YES in step S902), the processing proceeds to step S903. In step S903, the system control unit 50 sets a next search key to store it in the system memory 52. In FIG. 9, the search key is attribute information that is a unit of search. As a specific example, there are the date and time of a captured image, classification information, a folder, a moving image, and the like. In other words, in the image processing apparatus, when the date and time of a captured image, classification information, a folder, and a moving image can be searched, the date and time of a captured image, classification information, a folder, and a moving image to be classified with an image, which is recorded on the recording medium 200, are sequentially selected as the search key. Further, as sequential selection in FIG. 9, release of the search key, in other words, a shift of all images to a playback mode may also be included.

Next in step S904, the system control unit 50 determines whether the operated input is an image advance button, which is contained in the operation unit 70. When the operated input is the image advance button (YES in step S904), the processing proceeds to step S905. In step S905, the system control unit 50 reads a next display image in the search key set in step S903. The image advance button includes a pair of buttons corresponding to an advance direction. The next display image will be read in response to the advance direction corresponding to the operated button. Next, in step S906, the system control unit 50 executes file analysis processing of shooting information, attribute information, and the like to image data read in step S905. The file analysis processing will be described below. Then, in step S907, the system control unit 50 executes display of the image data read in step S905. At this time, the system control unit 50 displays shooting information, attribute information, and the like using the result of the file analysis processing in step S906. Further, as the result of the file analysis in step S906, when it has been determined that a part of the file is broken, the system control unit 50 also executes error display therewith. When the display is completed, the processing returns to the state of waiting for input in step S901.

In step S904, when it has been determined that the input is not the image advance button (NO in step S904), the processing proceeds to step S909.

In step S909, the system control unit 50 checks whether calculation processing of the total number of images is completed. When it is not still completed (NO instep S909), the processing returns to the state of waiting for an operated input in step S901. At this time, it is also considered to execute display of a message and an icon which notifies thereof to the effect that it is not still completed. By the processing described above, the image advance operation by the image advance button and the end processing by the end button are executed without waiting for completion of calculation of the number of images. However, other operated inputs are ignored until the calculation processing of the total number of images is completed.

In step S909, when it has been determined that calculation processing of the total number of images is completed (YES in step S909), the processing proceeds to step S912.

In step S912, the system control unit 50 checks whether the operated input is the operation of an erasure button to be contained in the operation unit 70. When it has been determined that it is the operated input of the erasure button (YES in step S912), the processing proceeds to step S913. In step S913, the system control unit 50 executes erasure of image data that is currently displayed on the image display unit 28. When erasure of the image data is completed, then in step S914, the system control unit 50 checks the total number of images after erasure. If the total number of images is zero (YES in step S914), the processing proceeds to step S915. Then, the processing is shifted to the state of waiting for input in the absence of an image. This processing is the same as that described in FIG. 8.

On the other hand, when image data remains after erasure (NO instep S914), the processing proceeds to step S916. In step S916, the system control unit 50 reads image data for next display in order to display next image data. In FIG. 9, the image data to be displayed is image data on a next file number of the file number of the erased image data. When latest image data has been erased, image data of a file number one file number before the file number of the erased image data is subject to display. In step S917, the system control unit 50 executes file analysis processing to the image data read as image data subjected to display in step S916 to obtain shooting information, attribute information, and the like. The file analysis processing will be described below. Then, in step S918, the system control unit 50 displays the image data read in step S916 on the image display unit 28. At this time, the shooting information, the attribute information, and the like acquired in step S917 are also displayed. Further, in response to the result of file analysis in step S917, when it has been determined that a part of the file is broken, the system control unit 50 executes error display to that effect. When display is completed, the processing returns to the state of waiting for an operated input in step S901.

In step S912, when the operated input is not an erasure button (NO instep S912), the processing proceeds to step S919. Instep S919, the system control unit 50 determines whether the operated input is an editing button. When it has been determined that the operated input is the editing button (YES in step S919), the processing proceeds to step S920. In step S920, the system control unit 50 executes editing processing to an image. Feasible editing processing when the editing button has been pressed includes resizing, cropping, image correction, and the like.

In step S919, when the operated input is not the editing button (NO instep S919), the processing proceeds to step S921. In step S921, the system control unit 50 determines whether the operated input is an end button. When it has been determined that the operated input is the end button (YES in step S921), the playback mode processing ends. The processing proceeds to step S310 in FIG. 3.

In step S921, when the operated input is not the end button (NO instep S921), the processing proceeds to step S924.

In step S924, the system control unit 50 executes processing corresponding to the operated input other than that described above. The processing includes, for example, editing processing of an image, change to multiple playback, menu display by a menu button, and the like. The multiple playback is a playback mode which displays a reduced image of image data on one screen of the image display unit 28 with a plurality of images arranged.

FIG. 10 is a flowchart illustrating image editing processing in step S920 illustrated in FIG. 9.

In step S1001, the system control unit 50 determines whether an image is editable. The editable image includes, for example, an image which is different in image format and cannot be recognized, or an image the resolution of which is smaller than a minimum resolution which can be handled by the apparatus as an image before processing when the editing processing is resizing processing or cropping processing. When it has been determined that the image is not editable (NO in step S1001), the processing ends. When it has been determined that the image is editable (YES in step S1001), the processing proceeds to step S1004. In step S1004, the system control unit 50 displays an editing menu on the image display unit 28 and allows a user to designate the content of editing processing using the operation unit 70. Then, the system control unit 50 interprets the designated content of the editing processing. Then, in step S1002, the system control unit 50 executes editing processing according to the designated content. This editing processing includes, for example, resizing, cropping, red-eye correction, and the like as described above. In editing processing, the system control unit 50 executes image processing and resolution conversion to the captured image data in response to the designation according to the designation of a resolution after a user has performed resizing or cropping processing.

Next, in step S1003, the system control unit 50 executes recording processing for recording image data after editing processing has been executed on a recording medium with header information and the like. Then, the processing ends.

In step S1003, when in the captured image data, the resolution of which has been made lower than the resolution of a medium resolution image for display in editing processing, particularly in reduction processing or cropping processing, the medium resolution image for display is deleted. This processing allows the prevention of inconvenience in which an image for display larger than image data required by a user may remain by editing processing after imaging and a recording capacity may be made useless.

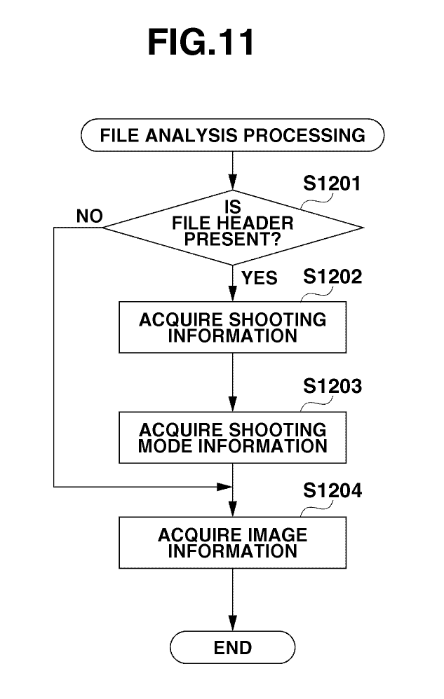

Next, file analysis processing in step S704 in FIG. 7 and steps S906 and 5917 in FIG. 9 will be described. FIG. 11 is a flowchart illustrating file analysis processing.

In step S1201, the system control unit 50 determines whether a file header recorded with shooting information and imaging mode information is present in a file to be analyzed. When it has been determined that the file header is present (YES in step S1201), then in step S1202, the system control unit 50 acquires shooting information from the file header. In step S1203, the system control unit 50 acquires shooting mode information from the file header. Then, in step S1204, the system control unit 50 acquires information concerning an image data main body such as an image main body start position and an image compression method.

In the present exemplary embodiment, a digital camera has been described as an example. However, the application of the present invention is not limited to this. For example, the present invention can also be applied to an image processing apparatus in which image data is input from an external device and the image data is configured as one image file with a thumbnail image and a medium resolution image.

Then, the imaging unit in the present exemplary embodiment is not limited to an imaging unit on a digital camera but may be, for example, a flatbed scanner or an apparatus for generating computer graphics. Further, the present invention can be applied to an image processing apparatus for configuring an image file from image data input from such an external device. Furthermore, the present invention can also be applied to a portable device in which an imaging apparatus is contained.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-143534 filed Jun. 16, 2009, which is hereby incorporated by reference herein in its entirety.

What is claimed is:

1. An apparatus comprising:
an input unit configured to input image data;
a reduced image generation unit configured to reduce the input image data to a predetermined resolution to generate reduced image data; and
a control unit configured to record, on a recording medium, the reduced image data as one file with the input image data if a resolution of the input image data is larger than the predetermined resolution and to record, on the recording medium, the image data as a file if the resolution of the input image data is not larger than the predetermined resolution.

2. The apparatus according to claim 1, further comprising a thumbnail image generation unit configured to generate, from the image data, a thumbnail image of a fixed resolution that is smaller than that of the reduced image data,
wherein the control unit records, on the recording medium, the reduced image data, the input image data, and the thumbnail image as one file if the resolution of the input image data is larger than the predetermined resolution, and records, on the recording medium, the thumbnail image data and the image data as one file if the resolution of the input image data is not larger than the predetermined resolution.

3. The apparatus according to claim 1, wherein the reduced image generation unit is configured to generate two or more types of reduced image data different in resolution to record as one file with the image data,
wherein the apparatus further comprises a setting unit configured to set the resolution of the input image data,
wherein the reduced image generation unit generates only reduced image data the resolution of which is smaller than the set resolution generating a reduced image the resolution of which is larger than the set resolution, and
wherein the control unit records a file with the image data using the generated reduced image data.

4. The apparatus according to claim 1, wherein the input unit includes an image sensor.

5. The apparatus according to claim 1, wherein the resolution of the reduced image data is set according to a display resolution of a display device.

6. The apparatus according to claim 1, further comprising a designation unit configured to designate a resolution of image data when reduction or cropping is executed on the image data,
wherein the control unit deletes a reduced image the resolution of which is larger than the designated resolution among reduced image data recorded in the file if the designated resolution is smaller than the resolution of the reduced image data.

7. A method comprising:
inputting image data;
reducing the input image data to a predetermined resolution to generate reduced image data; and
recording, on a recording medium, the generated reduced image data as one file with the input image data if a resolution of the input image data is larger than the predetermined resolution and recording, on the recording medium, the image data as a file if the resolution of the input image data is not larger than the predetermined resolution.

8. The method according to claim 7, further comprising:
generating, from the image data, a thumbnail image of a fixed resolution that is smaller than that of the reduced image data;
recording, on the recording medium, the reduced image data, the input image data, and the thumbnail image as one file if the resolution of the input image data is larger than the predetermined resolution; and
recording, on the recording medium, the thumbnail image data and the image data as one file if the resolution of the input image data is not larger than the predetermined resolution.

9. The method according to claim 7, further comprising:
generating two or more types of reduced image data different in resolution to record as one file with the image data;
setting the resolution of the input image data;
generating only reduced image data the resolution of which is smaller than the set resolution generating a reduced image the resolution of which is larger than the set resolution; and
recording a file with the image data using the generated reduced image data.

10. The method according to claim 7, wherein the resolution of the reduced image data is set according to a display resolution of a display device.

11. The method according to claim 7, further comprising:
designating a resolution of image data when reduction or cropping is executed on the image data; and
deleting a reduced image the resolution of which is larger than the designated resolution among reduced image data recorded in the file if the designated resolution is smaller than the resolution of the reduced image data.

12. An apparatus comprising:
a generation unit configured to reduce a captured image to generate a medium resolution image a resolution of which is smaller than that of the captured image and larger than that of a thumbnail image;
a recording unit configured to record the generated medium resolution image in one file with the captured image and the thumbnail image; and
a setting unit configured to set a resolution of an image acquired by an imaging unit,
wherein the recording unit performs control not to include the medium resolution image in the file if the set resolution is smaller than that of the medium resolution image.

13. The apparatus according to claim 12, wherein the recording unit does not record a medium resolution image a resolution of which is larger than the set resolution and records only a medium resolution image a resolution of which is smaller than the set resolution if two or more types of medium resolution images different in resolution are recordable in one file.

14. The apparatus according to claim 12, further comprising:
a second setting unit configured to set the resolution of the medium resolution image.

15. The apparatus according to claim 12, wherein the resolution of the medium resolution image is set according to a display resolution of a display device.

16. The imaging apparatus according to claim 13, further comprising:
a designation unit configured to designate a resolution of image data when reduction or cropping is executed on the image data; and
a control unit configured to delete the medium resolution image recorded in the file if the designated resolution is smaller than the resolution of the medium resolution image.

17. An apparatus in which image data, a thumbnail image, and a medium resolution image a resolution of which is smaller than that of the image data and larger than that of the thumbnail image are recorded as one file on a recording medium, and the image data is editable, the apparatus comprising:
a designation unit configured to designate a resolution of image data after reduction or cropping is executed on the image data; and
a control unit configured to delete the recorded medium resolution image if the designated resolution is smaller than the resolution of the medium resolution image.

18. A method comprising:
reducing a captured image to generate a medium thumbnail image a resolution of which is smaller than that of the captured image and larger than that of the thumbnail image;
recording the generated medium resolution image in one file with the captured image and the thumbnail image;
setting a resolution of an image acquired by an imaging operation; and
performing control not to include the medium resolution image in the file if the set resolution is smaller than a resolution of the medium resolution image.

19. The method according to claim 18, further comprising designating a resolution of image data when reducing or cropping is executed on the image data.

20. A method for controlling an apparatus in which image data, a thumbnail image, and a medium resolution image a resolution of which is smaller than that of the image data and larger than that of the thumbnail image are recorded as one file on a recording medium, and the image data is editable, the method comprising:
designating a resolution of image data after processing when reduction or cropping is executed on the image data; and
deleting the recorded medium resolution image if the designated resolution is smaller than the resolution of the medium resolution image.
